(19) United States
(12) Patent Application Publication
(10) Pub. No.: US 2024/0077947 A1
(43) Pub. Date: Mar. 7, 2024

(54) AI-BASED DIRECTION AWARENESS DURING CONTENT ENGAGEMENT

(71) Applicant: INTERNATIONAL BUSINESS MACHINES CORPORATION, ARMONK, NY (US)

(72) Inventors: Tushar Agrawal, West Fargo, ND (US); Christian Compton, Austin, TX (US); Jeremy R. Fox, Georgetown, TX (US); Sarbajit K. Rakshit, Kolkata (IN)

(21) Appl. No.: 17/930,379

(22) Filed: Sep. 7, 2022

(51) Int. Cl. G06F 3/01; G06F 3/0346; G06F 3/14; G06F 3/16; G06F 16/9532; G06F 16/9537; G06F 16/9538

(52) U.S. Cl. CPC G06F 3/017; G06F 3/013; G06F 3/014; G06F 3/0346; G06F 3/14; G06F 3/167; G06F 16/9532; G06F 16/9537; G06F 16/9538; G06F 2203/0331

(57) ABSTRACT

An embodiment for AI-based direction awareness during content engagement is provided. The embodiment may include receiving a query from a user on a primary device and data relating to an orientation of the primary device. The embodiment may also include presenting display content to the user on the primary device. The embodiment may further include in response to determining directional input is received from the user, identifying a relative distance and direction of the one or more wearable devices to the primary device. The embodiment may also include detecting a reference object. The embodiment may further include identifying a scaled distance of the one or more wearable devices to the reference object. The embodiment may also include adjusting the presented display content to include the reference object in a center of a screen of the primary device.

### BACKGROUND

The present invention relates generally to the field of computing, and more particularly to a system for AI-based direction awareness during content engagement.

Virtual assistants have become a common resource in consumer products for supplying answers to user-initiated queries. When utilizing these virtual assistants, users are able to submit different types of queries, and the virtual assistant may respond to the user by showing the result on a display (e.g., a mobile device or the virtual assistant itself) and/or via a voice-based reply. For example, the response from the virtual assistant may include, but is not limited to, images of an object, text from a document, pages of a book, and/or a map of a geographical area. As automation becomes commonplace, the demand for virtual assistants is expected to increase in the coming decades.

### SUMMARY

According to one embodiment, a method, computer system, and computer program product for AI-based direction awareness during content engagement is provided. The embodiment may include receiving a query from a user on a primary device and data relating to an orientation of the primary device. The embodiment may also include presenting display content to the user on the primary device based on the query and the orientation. The embodiment may further include in response to determining directional input is received from the user based on one or more actions of the user, identifying a relative distance and direction of the one or more wearable devices to the primary device. The embodiment may also include detecting a reference object based on the relative distance and direction. The embodiment may further include identifying a scaled distance of the one or more wearable devices to the reference object based on a scale of the display content. The embodiment may also include adjusting the presented display content to include the reference object in a center of a screen of the primary device based on the scaled distance.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for AI-based direction awareness during content engagement in a direction-aware content engagement process according to at least one embodiment.

FIG. 3 is a diagram depicting an operational example of a user navigating a street view with directional input according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for AI-based direction awareness during content engagement. The following described exemplary embodiments provide a system, method, and program product to, among other things, determine whether directional input is received along with a query and, accordingly, adjust presented display content to include a referenced object in a center of a screen of a primary device. Therefore, the present embodiment has the capacity to improve virtual assistant technology by dynamically adjusting display content based on directional cues of the user.

As previously described, virtual assistants have become a common resource in consumer products for supplying answers to user-initiated queries. When utilizing these virtual assistants, users are able to submit different types of queries, and the virtual assistant may respond to the user by showing the result on a display (e.g., a mobile device or the virtual assistant itself) and/or via a voice-based reply. For example, the response from the virtual assistant may include, but is not limited to, images of an object, text from a document, pages of a book, and/or a map of a geographical area. As automation becomes commonplace, the demand for virtual assistants is expected to increase in the coming decades. When the response from the virtual assistant is displayed to the user, the response may not factor into consideration directional cues from the user. This problem is typically addressed by retrieving information about points of interest based on a gesture of the user. However, simply retrieving information based on a gesture of the user fails to adjust the display content to show a desired directional view.

It may therefore be imperative to have a system in place to enhance a text or voice-based query with directional cues from the user. Thus, embodiments of the present invention may provide advantages including, but not limited to, dynamically adjusting display content based on directional cues of the user, adjusting the display content to show a desired directional view, and enhancing text or voice-based queries submitted by a user. The present invention does not require that all advantages need to be incorporated into every embodiment of the invention.

According to at least one embodiment, when a user is interacting with a display device, a query may be received from the user on a primary device along with data relating to an orientation of the primary device in order to present display content to the user on the primary device based on the query and the orientation. Upon presenting the display content, it may be determined whether directional input is received from the user based on one or more actions of the user. In response to determining the directional input is received from the user, a relative distance and direction of one or more wearable devices to the primary device may be identified so that a reference object may be detected based on the relative distance and direction. Then, a scaled distance of the one or more wearable devices to the reference object may be identified based on a scale of the display content in order to adjust the presented display content to include the reference object in a center of a screen of the primary device based on the scaled distance. According to at least one embodiment, a complete query may be constructed including the query, the directional input, and the reference object such that the presented display content is adjusted based on the complete query.

The present invention may be a system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether directional input is received along with a query and, accordingly, adjust presented display content to include a referenced object in a center of a screen of a primary device.

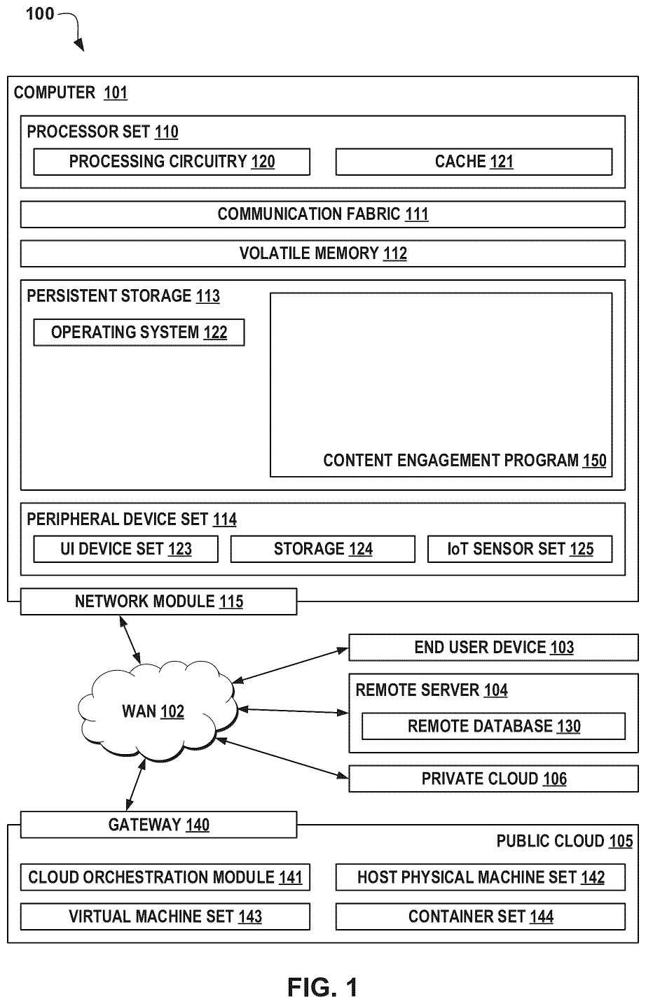

Referring to FIG. 1, an exemplary computing environment 100 is depicted, according to at least one embodiment. Computing environment 100 contains an example of an environment for the execution of at least some of the computer code involved in performing the inventive methods, such as a content engagement program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

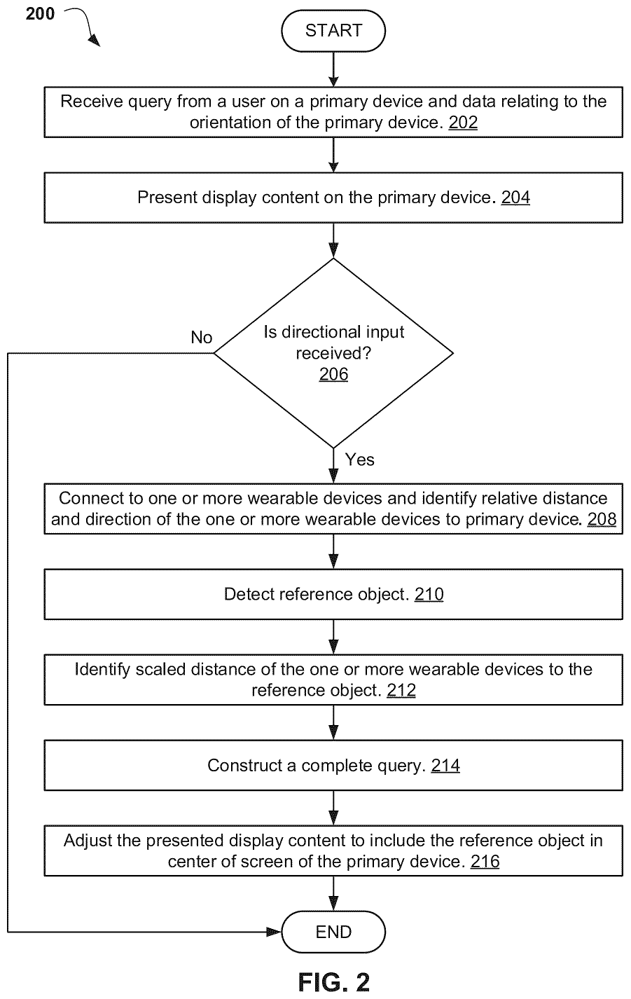

According to the present embodiment, the content engagement program 150 may be a program capable of receiving a query from a user on a primary device and data relating to an orientation of the primary device, determining whether directional input is received along with the query, adjusting presented display content to include a referenced object in a center of a screen of the primary device, dynamically adjusting display content based on directional cues of the user, adjusting the display content to show a desired directional view, and enhancing text or voice-based queries submitted by the user. Furthermore, notwithstanding depiction in computer 101, the content engagement program 150 may be stored in and/or executed by, individually or in any combination, end user device 103, remote server 104, public cloud 105, and private cloud 106. The content engagement method is explained in further detail below with respect to FIG. 2.

Referring now to FIG. 2, an operational flowchart for AI-based direction awareness during content engagement in a direction-aware content engagement process 200 is depicted according to at least one embodiment. At 202, the content engagement program 150 receives the query from the user on the primary device and the data relating to the orientation of the primary device.

The primary device may be a device that the user is currently interacting with. For example, the user may open a virtual assistant application on a smartphone to submit the query. The query may be a text-based query or a voice query. For example, when the user is navigating through a city or town, the user may say or type, “Show me a street view of my current location.”

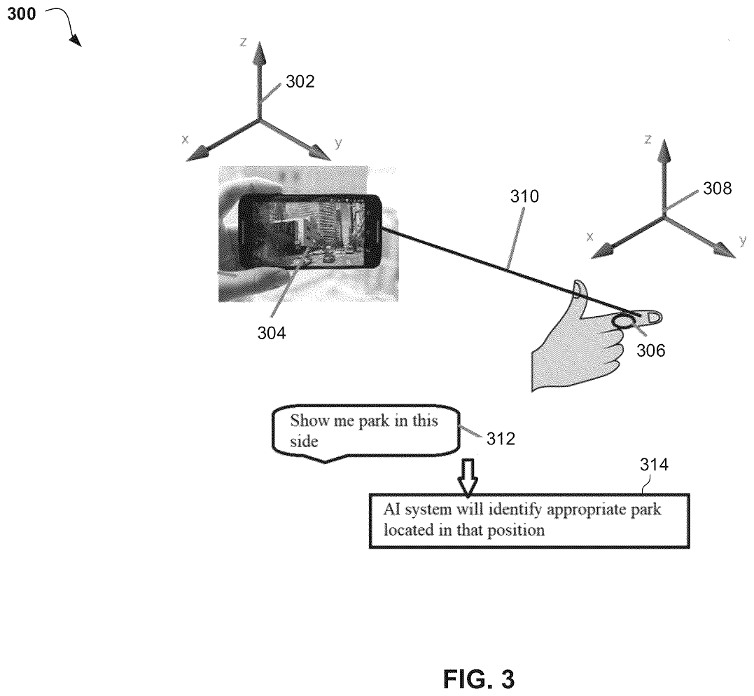

The data relating to the orientation of the primary device may be whether the primary device is being gripped in a horizontal (e.g., landscape) or vertical (e.g., portrait) direction and a 3D position of the primary device, illustrated in FIG. 3. The orientation may be detected by and received from IoT sensor set 125, such as the accelerometer and/or a compass application on the primary device. For example, where the primary device is gripped in a horizontal direction, the 3D position may be that a top surface of the primary device is facing west, a bottom surface is facing east, and the screen is facing south, where the top surface is the leftmost surface of the primary device. It may be appreciated that the examples described above and in the following paragraphs are not intended to be limiting, and that in embodiments of the present invention the query may be posed differently and the orientation of the primary device and directional input may vary.

Then, at 204, the content engagement program 150 presents the display content to the user on the primary device. The display content is presented based on the query and the orientation. Continuing the example described above where the query is, “Show me a street view of my current location,” and the primary device is gripped horizontally, the content engagement program 150 may present the street view of the current location in a horizontal orientation. When the user changes the orientation of the primary device, the display content may be presented in accordance with the changed orientation.

Next, at 206, the content engagement program 150 determines whether the directional input is received from the user. The determination is made based on the one or more actions of the user. Examples of the action include, but are not limited to, a hand gesture, an eye gesture, and/or a textual or voice command of the user. The directional input may be measured with respect to the 3D position of the primary device. For example, the hand gesture may include the raising of a hand to the left or right of the primary device and pointing of a finger to a reference object, described in further detail below with respect to step 210. Hand gestures may be detected from the one or more wearable devices, described in further detail below with respect to step 208. In another example, the eye gesture may include the user moving their eyes from the screen of the primary device toward the left or right of the primary device. Eye gestures may be detected by motion sensors embedded in the primary device and/or the wearable device. The textual or voice command may be used to supplement the directional input provided by the hand and/or eye gesture of the user, and is described in further detail below with respect to step 210. According to at least one embodiment, the directional input may be a cardinal direction such as, for example, North, South, East, West, Northeast, Northwest, Southeast, and Southwest. According to at least one other embodiment, the directional input may be an angle from the 3D position of the primary device such as, for example, 45° to the right of the primary device.

In response to determining the directional input is received from the user (step 206, “Yes” branch), the direction-aware content engagement process 200 proceeds to step 208 to connect to the one or more wearable devices and identify the relative distance and direction of the one or more wearable devices to the primary device. In response to determining the directional input is not received from the user (step 206, “No” branch), the direction-aware content engagement process 200 ends.

Then, at 208, the content engagement program 150 identifies the relative distance and direction of the one or more wearable devices to the primary device. The wearable device may be a smartwatch and/or a smart ring of the user, illustrated in FIG. 3. The one or more wearable devices may be wirelessly connected to the primary device and a signal may be transmitted between the primary device and the one or more wearable devices. The distance of the one or more wearable devices to the primary device may be identified based on the strength of the signal. For example, the distance between the smartwatch and the primary device may be 12 inches. The distance may provide general information as to a side of the primary device in which the one or more wearable devices are located. Continuing the example above where the smartwatch is 12 inches from the primary device, the 12 inches may be measured from a particular portion of the primary device, such as a bottom surface of the primary device. Continuing the example, when the primary device is gripped horizontally, the bottom surface may be the rightmost surface of the primary device, illustrated in FIG. 3. Thus, in this example, the smartwatch may be located on a right-hand side of the primary device.

Once the distance of the one or more wearable devices to the primary device is identified, the direction of the one or more wearable devices may be identified relative to the primary device. The direction may be a 3D position of the one or more wearable devices relative to the primary device. The direction may be identified by IoT sensor set 125, such as the accelerometer and/or a compass application on the one or more wearable devices. According to at least one embodiment, the direction may be a cardinal direction away from the primary device. For example, where the top surface of the primary device is facing west, a bottom surface is facing east, and the screen is facing south, where the top surface is the leftmost surface of the primary device, the user may raise their hand to the right of the bottom surface. In this example, the direction may be east. According to at least one other embodiment, the direction may be an angle of the one or more wearable devices from the 3D position of the primary device such as, for example, 180° to the right of the primary device.

Next, at 210, the content engagement program 150 detects the reference object. The reference object is detected based on the relative distance and direction described above with respect to step 208. The reference object may be any object in the surrounding environment to which the user is pointing with their finger. Since the smartwatch and/or the smart ring are worn on the wrist or fingers of the user, respectively, the direction of the finger may be inferred based on the relative distance and direction of the smartwatch and/or the smart ring. For example, when the user is navigating through a city or town, the user may point to a park. In another example, the user may point to a building. As described above, the textual or voice command may be used to supplement the directional input to detect the reference object. For example, the user may say or type, “Show me the park a block away to my right.” In this example, if there are two parks, one park being a block away and the other being two blocks away, the textual or voice command may assist the content engagement program 150 in detecting the appropriate park.

According to at least one embodiment, the reference object may be contained in the presented display content on the screen of the primary device. For example, the reference object may be displayed on the edge of the screen of the primary device. According to at least one other embodiment, the reference object may not be contained in the presented display content on the screen of the primary device. For example, the reference object may be too far from the primary device to be included in the presented display content.

According to a further embodiment, multiple reference objects may be considered. For example, the user may first point to the park, and then point to a building on a same side of the street two blocks away from the park. In this embodiment, any change in the eye gesture of the user results in the detection of a different reference object. For example, the user may be initially looking at and pointing to a park to the right of the user. While continuing to point, the user may then move their eyes to the left of the primary device to gaze at a building on the other side of the street. In this example, the change in the eye gesture of the user may result in the detection of the building as a reference object.

Then, at 212, the content engagement program 150 identifies the scaled distance of the one or more wearable devices to the reference object. The scaled distance is identified based on a scale of the display content. The scale of the display content may be a zoom level of the presented display content. For example, the user may zoom in and out of display content by pinching or spreading their fingers on the screen of the primary device. Continuing the example, the scale of the display content may be 1:100 (i.e., 100 times smaller than in real life). Then, the actual distance from the one or more wearable devices to the reference object may be identified. According to at least one embodiment, where the reference object is equipped with sensors, the actual distance from the one or more wearable devices to the reference object may be identified based on the signal strength, as described above with respect to step 208. According to at least one other embodiment, the actual distance from the one or more wearable devices to the reference object may be identified based on GPS and/or map data relating to the current physical location of the one or more wearable devices and the current physical location of the reference object. The scaled distance of the one or more wearable devices to the reference object may be identified as follows: Actual Distance±Zoom Level. For example, where the actual distance is 20 feet and the zoom level is 100 times smaller than in real life, the scaled distance may be 0.2 feet.

Next, at 214, the content engagement program 150 constructs the complete query including the query, the directional input, and the reference object. The complete query may be an enhanced query of the original query received from the user. For example, where the original query is, “Show me a street view of my current location,” the content engagement program 150 may add additional information to this query. Continuing the example, the user may raise their hand and point their finger 45° to the right of the primary device. To supplement the hand gesture, the user may also issue the textual or voice command, such as, “Show me the park one block away,” and a park may be detected as the reference object. The content engagement program 150 may add this directional input and reference object to the original query. For example, the complete query may be, “Show me a street view of my current location, specifically the park one block away and 45° to the right of the primary device.” It may be appreciated that the examples described above are not intended to be limiting, and that in embodiments of the present invention the complete query may be constructed in a different format and include a different reference object.

Then, at 216, the content engagement program 150 adjusts the presented display content to include the reference object in the center of the screen of the primary device. The presented display content is adjusted based on the scaled distance described above with respect to step 212. Continuing the example above where the Actual Distance±Zoom Level (i.e., the scaled distance) is 0.2 feet, the content engagement program 150 may search for graphics 0.2 feet in the direction of the reference object. The presented display content may then be adjusted to include the results of the search (i.e., the reference object) in the center of the screen of the primary device. The presented display content may be adjusted by shifting the displayed images in the direction of the scaled distance. For example, when the scaled distance is 0.2 feet based on the current scale of the display content, the displayed images may be shifted 0.2 feet in the direction of the reference object. The adjusted display content may be presented to the user with an identical scale to the scale of the display content. For example, where the scale of the display content is 1:100, the scale of the adjusted display content may also be 1:100.

According to at least one embodiment, where the complete query is constructed to enhance the original query, the presented display content may also be adjusted based on the constructed query. Continuing the example above where the complete query is, “Show me a street view of my current location, specifically the park one block away and 45° to the right of the primary device,” the presented display content may be adjusted by shifting the displayed images in the direction of the park one block away and 45° to the right of the primary device.

According to at least one other embodiment, adjusting the presented display content may also include relocating at least one object that is blocking a view of the reference object on the primary device. The at least one object may be relocated in response to a voice command from the user to relocate the at least one object. For example, where the reference object is a building, one or more lampposts may be fully or partially blocking a view of the building from the current location of the user. The user may say, for example, “move the lampposts to the left so I can view the building.” Continuing the example, the content engagement program 150 may relocate the lampposts to the left in accordance with the voice command. It may be appreciated that the example described above is not intended to be limiting, and that in embodiments of the present invention the voice command may be stated differently.

Referring now to FIG. 3, a diagram 300 depicting an operational example of a user navigating a street view with directional input is shown according to at least one embodiment. In the diagram 300, a first 3D position 302 of the primary device, such as a smartphone, may be determined and the display content 304 may be presented to the user consistent with the first 3D position 302 of the primary device. For example, the display content 304 may be presented in a landscape view. The directional input may include a hand gesture by the user where the user is pointing an index finger in the direction of the reference object. A smart ring 306 on the index finger of the user may connect wirelessly to the smartphone to identify the distance 310 between the smartphone and the smart ring 306. The smart ring 306 may also be equipped with the accelerometer and/or the compass application, and based on the distance 310 and data from the accelerometer and/or the compass application, a second 3D position 308 of the smart ring 306 may be identified in relation to the first 3D position 302 of the primary device. The user may issue the voice command 312 to supplement the directional input. The voice command 312 may be, for example, “Show me the park in this side.” The content engagement program 150 may, in response to the directional input and/or the voice command 312, perform a search for graphics and the search results 314 to the user in the form of the adjusted display content.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of AI-based direction awareness during content engagement, the method comprising:
receiving a query from a user on a primary device and data relating to an orientation of the primary device;
presenting display content to the user on the primary device based on the query and the orientation;
determining whether directional input is received from the user based on one or more actions of the user;
in response to determining the directional input is received from the user, identifying a relative distance and direction of one or more wearable devices to the primary device;
detecting a reference object based on the relative distance and direction;
identifying a scaled distance of the one or more wearable devices to the reference object based on a scale of the display content; and
adjusting the presented display content to include the reference object in a center of a screen of the primary device based on the scaled distance.

2. The computer-based method of claim 1, further comprising:
constructing a complete query including the query, the directional input, and the reference object, wherein the presented display content is adjusted based on the complete query.

3. The computer-based method of claim 2, wherein the adjusted display content is presented to the user with an identical scale to the scale of the display content.

4. The computer-based method of claim 1, wherein the one or more actions of the user include a hand gesture, an eye gesture, and a voice command of the user.

5. The computer-based method of claim 4, wherein a change in the eye gesture of the user results in the detection of a different reference object.

6. The computer-based method of claim 1, wherein adjusting the presented display content further comprises:
relocating at least one object that is blocking a view of the reference object on the primary device in response to a voice command from the user to relocate the at least one object.

7. The computer-based method of claim 1, wherein the wearable device is selected from a group consisting of a smartwatch and a smart ring.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving a query from a user on a primary device and data relating to an orientation of the primary device;
presenting display content to the user on the primary device based on the query and the orientation;
determining whether directional input is received from the user based on one or more actions of the user;
in response to determining the directional input is received from the user, identifying a relative distance and direction of one or more wearable devices to the primary device;
detecting a reference object based on the relative distance and direction;
identifying a scaled distance of the one or more wearable devices to the reference object based on a scale of the display content; and
adjusting the presented display content to include the reference object in a center of a screen of the primary device based on the scaled distance.

9. The computer system of claim 8, further comprising:
constructing a complete query including the query, the directional input, and the reference object, wherein the presented display content is adjusted based on the complete query.

10. The computer system of claim 9, wherein the adjusted display content is presented to the user with an identical scale to the scale of the display content.

11. The computer system of claim 8, wherein the one or more actions of the user include a hand gesture, an eye gesture, and a voice command of the user.

12. The computer system of claim 11, wherein a change in the eye gesture of the user results in the detection of a different reference object.

13. The computer system of claim 8, wherein adjusting the presented display content further comprises:
relocating at least one object that is blocking a view of the reference object on the primary device in response to a voice command from the user to relocate the at least one object.

14. The computer system of claim 8, wherein the wearable device is selected from a group consisting of a smartwatch and a smart ring.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving a query from a user on a primary device and data relating to an orientation of the primary device;
presenting display content to the user on the primary device based on the query and the orientation;
determining whether directional input is received from the user based on one or more actions of the user;
in response to determining the directional input is received from the user, identifying a relative distance and direction of one or more wearable devices to the primary device;
detecting a reference object based on the relative distance and direction;
identifying a scaled distance of the one or more wearable devices to the reference object based on a scale of the display content; and
adjusting the presented display content to include the reference object in a center of a screen of the primary device based on the scaled distance.

16. The computer program product of claim 15, further comprising:
constructing a complete query including the query, the directional input, and the reference object, wherein the presented display content is adjusted based on the complete query.

17. The computer program product of claim 16, wherein the adjusted display content is presented to the user with an identical scale to the scale of the display content.

18. The computer program product of claim 15, wherein the one or more actions of the user include a hand gesture, an eye gesture, and a voice command of the user.

19. The computer program product of claim 18, wherein a change in the eye gesture of the user results in the detection of a different reference object.

20. The computer program product of claim 15, wherein adjusting the presented display content further comprises:
relocating at least one object that is blocking a view of the reference object on the primary device in response to a voice command from the user to relocate the at least one object.
